(19) United States
(12) Patent Application Publication
(10) Pub. No.: US 2024/0402519 A1
(43) Pub. Date: Dec. 5, 2024

(54) CONTACT LENSES COMBINING CHROMATICITY AND DEFOCUS FOR MYOPIA CONTROL

(71) Applicant: Performance Vision Technologies, Inc., Lake Oswego, OR (US)

(72) Inventors: Alan Wayne Reichow, Cedar Falls, IA (US); Karl M. Citek, Hillsboro, OR (US); Joseph E. Sicari, Naples, FL (US); Mark Paul Andre, Bend, OR (US)

(73) Assignee: Performance Vision Technologies, Inc., Lake Oswego, OR (US)

(21) Appl. No.: 18/798,527

(22) Filed: Aug. 8, 2024

Related U.S. Application Data
(63) Continuation-in-part of application No. 17/847,100, filed on Jun. 22, 2022.
(60) Provisional application No. 63/214,221, filed on Jun. 23, 2021.

(51) Int. Cl. G02C 7/10; G02C 7/04

(52) U.S. Cl. CPC G02C 7/104; G02C 7/044; G02C 7/108; G02C 2202/24

(57) ABSTRACT

Lenses are tinted for control of myopia development. These myopia control tints can be provided in contact lenses, eyeglass lenses, goggles, or other viewing optics. In some cases, dual zone lenses include a clear vision portion and a defocus portion in combination with the myopia control tints. While users can find that lenses with a defocus zone provoke a feeling of blurred vision, the myopia control tints can address the perceived defocus and provide superior user comfort.

### CROSS REFERENCE TO RELATED APPLICATIONS

This application is a Continuation-in-Part of U.S. patent application Ser. No. 17/847,100, filed Jun. 22, 2022, which claims the benefit of U.S. Provisional Patent Application 63/214,221, filed Jun. 23, 2021, both of which incorporated herein by reference.

### FIELD

The disclosure pertains to contact lenses configured to enhance visual performance.

### BACKGROUND

Conventional vision correction whether via eyewear or contact lenses can often provide wearers so-called normal visual acuity, even in wearers requiring corrections of high power. Tints for controlling light intensity can be provided in corrective or non-corrective eyewear. However, conventional eyewear and contact lenses while providing focus correction are generally unable to enhance a wearer's visual perception which is often a key aspect of achieving high performance. suffered brain injury to control, reduce, or eliminate symptoms.

Conventional vision correction approaches can improve vision in myopes but do not address the prevention or diminution of myopia. Myopia is a growing global epidemic that affects more than two billion people worldwide, with 42% of US adults and up to 80-90% of people in East Asia affected. By 2050 myopia is predicted to affect 50% of the global population, and increase uncorrected visual impairment in the US and globally by 2-to 4-fold. Concerns surrounding this growing health problem from myopia are increasing because axial length elongation of the eye associated with myopia is a major risk factor for a number of sight-threatening ocular pathologies, such as maculopathy and retinal detachment, which can cause irreversible blindness. Myopic maculopathy is the leading cause of blindness in countries with a high prevalence of myopia. Compared to an emmetropic eye, even low to moderate amounts of myopia can significantly increase the risks of developing these ocular pathologies, and for individuals with high myopia these risks are immense. Most myopia results from a failure of the emmetropization mechanism in children that normally regulates axial elongation of the eye in order to maintain clear visual focus at distance (emmetropia).

The urgent need for development of new anti-myopia control strategies has become a global priority and new and effective methods of intervention are needed. Such new anti-myopia treatments can be used separately, or integrated with existing treatments to create even more effective outcomes. Traditional methods and technologies such as single-vision spectacles, single-vision contact lenses and refractive surgery correct the eye's optical focus to restore clear central distance vision but are ineffective in slowing eye growth and reducing the risks associated with myopia later in life. Other optical and pharmacological approaches have been developed to slow myopia progression. These conventional control methods and technologies are partially effective, at best. Typical results demonstrate a slowing of axial elongation in myopia progression by 30-60% and are generally limited to a maximum efficacy of 0.45 mm or 1 Diopter. These interventions include the use of pharmaceuticals which can cause undesirable side effects such as increased light sensitivity and blurred near vision. Orthokeratology requires a significant time and resource commitment and has side effects such as dry eyes, eye irritation, increased sensitivity to light and glare, and blurred vision during the day when not wearing the orthokeratology lenses. Other approaches are based on dual focus lenses which provide a peripheral defocus which is only partially effective and compromises visual acuity for distance vision. These and other conventional optical methods for myopia control use a single visual cue—peripheral myopic defocus—as a stimulus to slow eye growth. Although these methods are clinically effective to some extent, they still allow significant myopic progression and a myopic defocus cue appears insufficient to optimally restrain eye growth and myopia progression. In view of the above shortcomings, additional approaches are needed to address myopia control.

### SUMMARY

The disclosure pertains to single-use soft contact lenses for wearers who do or do not use or require corrective lenses. This disclosure also pertains to tinted optics for myopia control such as dual focus lenses, including contact lenses which can be employed to slow the development of myopia. In some examples, the contact lenses are configured for use by emmetropes or users who normally do not wear contact lenses. A variety of contact lens tints are disclosed that filter out ultraviolet radiation (UVR) and manipulate the visible spectrum (VIS) to the benefit of the wearer. Such single-use contact lenses can provide distortion free, wide angle improvements that are unavailable with eyewear. In addition, the disclosed contact lenses can be configured to be more easily handled than conventional correct for ease of use, particularly be emmetropes who are generally unfamiliar with and unaccustomed to contact lens handling.

The disclosed contact lenses are provided with tints that enhance performance and can be shaped to permit wearing by individuals who are unfamiliar with contact lens handlings. With suitable contact lens shapes, applying and removing the contact lenses is simple, and providing tints on a contact lens permits using more transmissive tints than would be needed for spectacles or goggles. In addition, using tinted contact lenses avoids some of the physical limitations and problems associated with spectacles and goggles.

Through Light Architecture (LA), both the quantity and quality of VIS are controlled to achieve the desired results. Depending on the specific requirements, VIS wavelengths shorter than about 500 nm (blue), known as High Energy Visible (HEV or HEV light), are attenuated or eliminated which reduces chromatic aberration and light scatter within the eye, improves visual comfort, and addresses color perception in consideration of the visual and environmental demands of particular activities, including varying light conditions associated with a selected activity. Within the wavelength range of Peak Visual Sensitivity (PVS or PVS light) of the human eye, from about 500 to 600 nm (green-yellow), VIS transmission is selected to target design objectives of improved visibility of objects and targets with respect to their backgrounds. In the wavelength range of Low Energy Visible (LEV or LEV light), that is, from about 600 to 760 nm (red), sensitivity of the human eye is much lower than in the PVS range and transmission is selected based on color requirements of specific activities. HEV, PVS, LEV and light color designations such as red (R), green (G), blue (B) and others are used in discussing some of the following examples, but may not completely characterize the associated visual appearance. For example, LEV light includes portions that appear orange as well as red, some portions of PVS light may appear orange-yellow, but these approximate ranges are nevertheless useful for convenient description.

Various light source spectra are considered in the task-specific tints such as natural sunlight, emissive electronic display devices, and stadium lighting. With total tint immersion resulting from complete eye coverage by the representative examples of the disclosed contact lenses that extends beyond the cornea and onto the sclera, Visible Light Transmission (VLT) can be significantly higher (100%, 150%, 200% or more higher) than in conventional tinted spectacles. In one disclosed example, a contact lens has a 36% VLT versus a conventional gray tinted sunglass lens having a 13% VLT. By eliminating peripheral light leakage with the disclosed contact lenses, higher VLTs can be used. With the disclosed contact lenses (and the associated greater VLTs), a wearer's pupil can more accurately respond to lighting conditions, including visual target brightness and immediate surrounds. In addition, the disclosed contact lenses can be configured for non-corrective, non-contact lens wearers to enhance ease of handling and improve initial comfort based on selection of contact lens center thickness, diameter, base curve, and sagittal height (SAG). Finally, the disclosed contact lenses provide superior visual performance due to eliminating the distance (the vertex distance) from the eye to the tinted lens. These and other features and advantages are discussed below with respect to example embodiments.

### BRIEF DESCRIPTION OF THE DRAWINGS

FIG. 1A is a graph illustrating normalized spectra of three light sources, Illuminant C, Illuminant D65, and deluxe cool white fluorescent (DXCW FL), in terms of relative energy emitted.

FIG. 1B is a graph illustrating normalized spectra of three light sources, a cool white (CW) light emitting diode (LED), a warm white (WW) LED, and a high intensity discharge (HID), in terms of relative energy emitted.

FIG. 2 is a CIE (1931) Standard Chromaticity Diagram showing a region perceived as “white” under average (Avg.) daylight illumination (D65) and plots of several light sources: Illuminant C, Illuminant D65, a cool white (CW) light emitting diode (LED), a deluxe cool white fluorescent (DXCW FL), a high intensity discharge (HID), and a warm white (WW) LED.

FIG. 3A illustrates a transmission spectrum of a tint ND 36%, including spectral ranges: UV=ultraviolet, V=violet, B=blue, G=green, Y=yellow, O=orange, R=red, IR=infrared.

FIG. 3B is a CIE (1931) standard chromaticity diagram for the tint ND 36% of FIG. 3a, including regions defining green and yellow traffic signals, “white” (avg. daylight (D65)), and plots of the tint for green, yellow, and red lights under Illuminant D65, as well as various light sources: C=Illuminant C, D65=Illuminant D65, DXCW FL=deluxe cool white fluorescent, CW LED=cool white LED, HID=high intensity discharge, WW LED=warm white LED.

FIG. 4A illustrates a transmission spectrum of a tint Amber 50%, including spectral ranges: UV=ultraviolet, V=violet, B=blue, G=green, Y=yellow, O=orange, R=red, IR=infrared.

FIG. 4B is a CIE (1931) standard chromaticity diagram for the tint Amber 50% of FIG. 4a, including regions defining Green and Yellow Traffic signals, “white” (Avg. Daylight (D65)), and plots of the tint for Green, Yellow, and Red lights under Illuminant D65, as well as various light sources: C, D65, DXCW FL, CW LED, HID, and WW LED as in FIG. 3b.

FIG. 5A illustrates a transmission spectrum of a tint Grey Green 36%, including spectral ranges: UV=ultraviolet, V=violet, B=blue, G=green, Y=yellow, O=orange, R=red, IR=infrared.

FIG. 5B is a CIE (1931) standard chromaticity diagram for the tint Grey Green 36% of FIG. 5A, including regions defining Green and Yellow Traffic signals, “white” (Avg. Daylight (D65)), and plots of the tint for Green, Yellow, and Red lights under Illuminant D65, as well as various light sources: C=Illuminant C, D65 =Illuminant D65, DXCW FL=deluxe cool white fluorescent, CW LED=cool white LED, HID=high intensity discharge, WW LED=warm white LED.

FIG. 6A illustrates transmission spectrum of a tint Stadium 80%, including spectral ranges: UV=ultraviolet, V=violet, B=blue, G=green, Y=yellow, O=orange, R=red, IR=infrared.

FIG. 6B is a CIE (1931) standard chromaticity diagram for the tint Stadium 80% of FIG. 6A including regions defining Green and Yellow Traffic signals, “white” (Avg. Daylight (D65)), and plots of the tint for Green, Yellow, and Red lights under Illuminant D65, as well as various light sources: C=Illuminant C, D65=Illuminant D65, DXCW FL=deluxe cool white fluorescent, CW LED=cool white LED, HID=high intensity discharge, WW LED=warm white LED.

FIG. 6C illustrates design and as-fabricated transmission spectra of the tint Stadium 80% of FIG. 6A.

FIG. 7A illustrates transmission spectrum of a tint Gaming 84%, including spectral ranges: UV=ultraviolet, V=violet, B=blue, G=green, Y=yellow, O=orange, R=red, IR=infrared.

FIG. 7B is a CIE (1931) standard chromaticity diagram for the tint Gaming 84% of FIG. 7A, including regions defining Green and Yellow Traffic signals, “white” (Avg. Daylight (D65)), and plots of the tint for Green, Yellow, and Red lights under Illuminant D65, as well as various light sources: C=Illuminant C, D65=Illuminant D65, DXCW FL=deluxe cool white fluorescent, CW LED=cool white LED, HID=high intensity discharge, WW LED=warm white LED.

FIG. 8A illustrates a transmission spectrum of a tint Gaming 65%, including spectral ranges: UV=ultraviolet, V=violet, B=blue, G=green, Y=yellow, O=orange, R=red, IR=infrared.

FIG. 8B is a CIE (1931) standard chromaticity diagram for the tint Gaming 65%, including regions defining Green and Yellow Traffic signals, “white” (Avg. Daylight (D65)), and plots of the tint for Green, Yellow, and Red lights under Illuminant D65, as well as various light sources: C=Illuminant C, D65=Illuminant D65, DXCW FL=deluxe cool white fluorescent, CW LED=cool white LED, HID=high intensity discharge, WW LED=warm white LED.

FIG. 9A is a transmission spectrum of a tint ND 75%, including spectral ranges: UV=ultraviolet, V=violet, B=blue, G=green, Y=yellow, O=orange, R=red, IR=infrared.

FIG. 9B is a CIE (1931) standard chromaticity diagram for the tint ND 75%, including regions defining Green and Yellow Traffic signals, “white” (Avg. Daylight (D65)), and plots of the tint for Green, Yellow, and Red lights under Illuminant D65, as well as various light sources: C=Illuminant C, D65=Illuminant D65, DXCW FL=deluxe cool white fluorescent, CW LED=cool white LED, HID=high intensity discharge, WW LED=warm white LED.

FIG. 10 illustrates a representative contact lens.

FIGS. 11A-11B illustrates representative methods.

FIGS. 12A-12B illustrate reduction of visual noise using the disclosed tinted contact lenses with tints such as illustrated in FIGS. 4a and 5a.

FIG. 13 illustrates myopia control tints.

FIG. 14A is sectional view of a dual focus myopia control contact lens.

FIG. 14B is an elevational view of the dual focus myopia control contact lens of FIG. 14A.

FIG. 15 illustrate a dual focus lens with myopia control tinted layers.

### DETAILED DESCRIPTION

Optimized vision is the primary guiding sense to human performance. Being able to clearly see the field of play, the opponents, the targets, the ball—all of the elements of the athlete's competitive environment—is an essential element to bolstering an athlete's confidence and performance. The disclosed tinted contact lenses can eliminate visual distractions such as lighting glare while elevating critical visual details, such as visual clarity and contrast, to enhance athlete performance. These disclosed contact lenses select the quantity and quality of light experienced by the wearer in a series of activity-specific tints, formulated into a matrix of a single-use soft contact lens to address the unique environmental and visual demands of particular sports or other activities and particular conditions: harsh stadium or arena lights; tracking a 90 mph pitch under glare or shadow; catching a 50 yard touchdown pass when the ball is lost in the sun; surfing with a sharp glare off the water; and many other vision-critical activities. Each situation has unique visual and environmental demands, and the disclosed contact lenses can mitigate visual noise with the goal of allowing the athlete to perform with maximal comfort, clarity and quickness under varying visual and environmental conditions encountered in sports and recreation.

Conventional sunglasses fail to address the performance-specific visual demands addressed by the disclosed contact lenses. Such conventional eyewear introduces visual distortion and does not adequately control visual noise and clutter. By eliminating the vertex distance of such wearable eyewear (including goggles or shields), and positioning performance-tints on the eye as contact lenses these induced optical distortions are eliminated while also addressing other visual and environmental issues and concerns encountered in human performance when wearing tinted eyewear. The disclosed contact lenses can eliminate fogging, obscuration due to sweating, lens scratching, provide enhanced comfort, promote visual quickness, provide UVR protection and blue light filtration. Other areas of enhanced optical performance include visual clarity, contrast sensitivity, glare recovery, dark adaptation, unimpeded peripheral vision, depth perception, and accuracy of spatial localization and object tracking.

The disclosed contact lenses are generally described herein as providing little to no optical power, i.e., contact lenses suitable for wearers who require no correction. Corrective lenses can also be provided using suitable curvatures or other shapes, but athletes or other users of the disclosed lenses are in many cases unfamiliar with care and handling of contact lenses. That is, many or most wearers of the disclosed contact lenses can be emmetropes requiring plano power. The disclosed lenses include these performance-based tints in single-use, soft contact lenses with curvatures, thicknesses, and diameters that permit improved comfort and ease of handling.

### The Human Visual System and Color Vision

For convenience, certain color characteristics of human vision are briefly summarized. The human visual system is sensitive to a narrow band of electromagnetic radiation referred to herein as light. Within this band of radiation, VIS, with wavelengths from about 380 nanometers (nm) to about 760 nm, the visual system perceives different wavelengths as unique and distinct colors (see Table 1).

TABLE 1
Approximate wavelength ranges of colors of the
visible spectrum.

| Color | Starting at about . . . | Ending at about . . . |
|---|---|---|
| Violet | 380 nm | 450 nm |
| Blue | 450 nm | 500 nm |
| Green | 500 nm | 560 nm |
| Yellow | 560 nm | 590 nm |
| Orange | 590 nm | 620 nm |
| Red | 620 nm | 760 nm |

Wavelengths of radiation shorter than 380 nm are classified as UVR, while wavelengths longer than 760 nm are classified as infrared (IR). Neither of these types of radiation is visible to the human eye, and while IR in the natural environment is essentially harmless, UVR exposure from sunlight can cause damage to the skin and the eye, such as sunburn, keratitis, pterygium, and cataracts.

Color ranges do not have sharp, well-defined boundaries. Color mixing is possible throughout the visible spectrum. For example, for persons with normal color vision, light of wavelength 500 nm has a bluish-green appearance, while light of wavelength 590 nm has a yellowish-orange appearance. In addition, light of a single wavelength has a solid, pure color appearance, known as a saturated color, while light comprised of multiple wavelengths may have only a hint or tinge of color, such as a pastel, known as desaturated color.

The human visual system has peak sensitivity in normal lighting (e.g., daylight) to light of wavelength of about 555 nm, which has a greenish-yellow appearance. At nighttime, under low light level conditions (e.g., on a moonlit night with no other illumination), peak sensitivity is at about 505 nm.

White light often is thought to be composed of all wavelengths of visible light. Yet as few as two carefully-chosen colored lights, known as complements, can give the perception of “white” to a person with normal color vision. For example, the proper combination of red and blue lights can appear white, as can the proper combination of violet and yellow lights. Color vision deficiency (CVD) is a common malady, usually inherited as a sex-linked trait. The most common type of CVD is red-green confusion, in which red and green objects are seen to be similar or even identical in color. About 8% of all males and 0.5% of all females have some level of red-green CVD, ranging from mild to severe. The other type of CVD, blue-yellow confusion, is very rare naturally, but occurs most commonly with disease conditions, such as cataract, or drug therapy, such as quinine; once the cataract is removed or the drug therapy is stopped, color vision will return to its earlier state.

A tinted lens can be beneficial to any wearer in the right environment, for example, to allow easier discrimination of an object from the background, such as a colored ball seen against green grass, red clay, or blue sky, or to reduce visual stress, such as can occur when viewing a computer monitor for extended periods of time as in computer gaming. As one example, a colored tint that reduces the amount of blue and violet light entering the eye reduces the chromatic aberration of the eye (i.e., the natural separation of light of different wavelengths as the light passes from one medium, such as air, into another medium, such as the structure of the eye), thus creating an increase in perceived image clarity and contrast.

By reducing the chromatic aberration of the eye, the tinted contact lens can reduce some of the need for optical correction. For example, wearers who need distance correction greater than that available with a selected lens power may achieve adequate visual clarity with a tinted lens close to but not equal to the power of the needed correction. Likewise, wearers who have astigmatism may achieve adequate visual clarity with a tinted lens having only spherical correction power. In addition, wearers who normally use bifocal contact lenses or have difficulty viewing objects up close may achieve adequate visual clarity for near objects when wearing the tinted contact lens with only distance correction power. Furthermore, even emmetropes can experience enhanced vision with a reduction in chromatic aberration. Light at wavelengths that are not appropriately focused are sensed by the eye but are not effective in image formation and are referred to herein as producing “visual noise.”

But a tinted lens, whether provided as a spectacle, goggle, or contact lens, can alter color detection even in persons with normal color vision but especially in those with CVD. Nonetheless, a person may not be aware that color detection is not accurate when viewing through a tinted lens because the perception of colors changes less than the physical change in the color make-up of the object, known as color constancy. However, in some everyday situations, proper identification of colored lights and objects is critical, even if someone does not see the colors “correctly,” whether because of CVD or use of a tinted lens. One significant example is identification of traffic signals when driving. Persons with CVD, and even those with normal color vision, should exercise caution and consult with an eye doctor before using any tinted lens for activities in which accurate color detection is necessary, such as driving.

### Light Sources

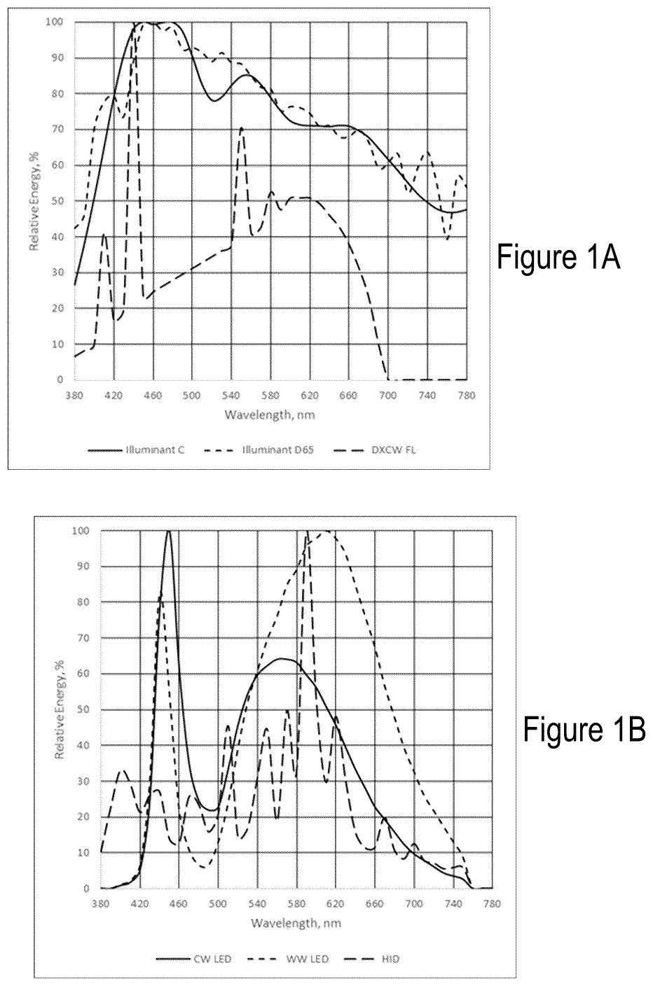

The most common source of “white” light is natural sunlight, whose spectrum in the visible range is given by the standard Illuminant C (see FIG. 1A). An artificial light source with a very similar spectrum is Illuminant D65 (see FIG. 1A). Also shown in FIG. 1A is the spectrum of a typical deluxe cool-white, fluorescent light, frequently used in indoor lighting but also often used as the illumination source of computer monitors and televisions. FIG. 1B shows the spectra for a high-intensity discharge (HID) light, such as is often used in sports stadiums and arenas, and two types of light emitting diode (LED) lights, cool white and warm white, such as those used in indoor lighting and increasingly in small screen computers, such as laptops and tablets, and smartphones.

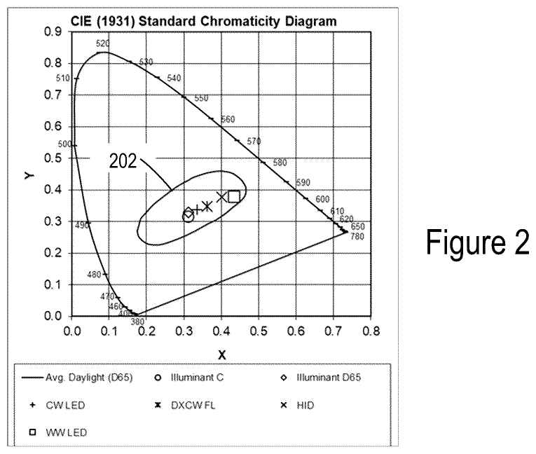

One method of characterizing the color appearance of a light is to compare its spectrum to the visual sensitivity of the human eye and plot the result on a chromaticity diagram, such as shown in FIG. 2. Any data point that falls within a central oval 202 defining “average daylight” will in general have a white appearance. The closer that a data point associated with a particular light source and tint is to the position of Illuminant C, the “whiter” the associated light will appear. Color coordinate values (X, Y) further away from the position of Illuminant C and towards the edge of the diagram are associated with a colored appearance. For example, while the warm white LED is within the “average daylight” range, it has a definite orange-reddish tinge or appearance when compared with Illuminant C, and the HID light only a bit less so.

### Representative Performance Tints

Transmittance curves for various embodiments of performance contact lens tints are presented. Each curve plots the transmission of the tint, in per cent, against the wavelength of light from 300 nm to 800 nm. For reference, the approximate color ranges (see Table 1) are also shown. All tints prevent harmful UVR, i.e., wavelengths shorter than 380 nm, from reaching the eye. Additionally, since each tint is within the entirety of a soft contact lens, and the contact lens is in contact with and larger than the cornea of the wearer's eye, there is no leakage of light entering the eye from behind or to the side of the wearer. Consequently, a tinted contact lens does not need to filter as much light as a tinted spectacle or goggle lens in order to achieve a similar effective reduction of light actually entering the eye.

Each CIE chromaticity diagram plots the color appearance of objects in average daylight (D65). For persons with normal color vision, white objects will appear white, or white with a slight color tinge, if the tint (open and gray-shaded symbols) occurs within the central oval (marked as “Avg. Daylight (D65)”); if the tint plots outside the central circle, white objects will have a definite non-white color appearance. Green traffic signals will appear green if the tint (closed circle) occurs within the dash-dotted region in the upper left of the diagram (marked “Green Traffic”); if the tint plots outside this region, green traffic signals will not be seen as green. Yellow traffic signals will appear yellow if the tint (closed square) occurs within the dashed region in the right center of the diagram (marked “Yellow Traffic”); if the tint plots outside this region, yellow traffic signals will not be seen as yellow. Red traffic signals will appear red if the tint (closed diamond) occurs along the border at the lower right corner of the diagram, at wavelengths within the LEV range; if the tint plots away from the border, red traffic signals will not be seen as red.

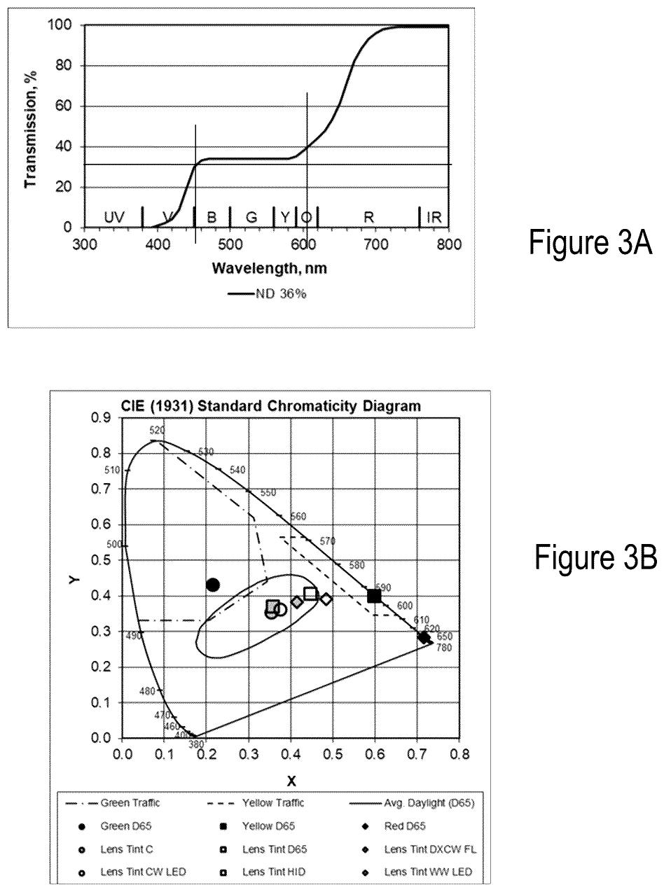

In general, an ideal neutral density (ND) tint does not alter color perception, since it reduces the transmittance of all wavelengths of the visible spectrum equally. One embodiment that minimally affects color perception is the ND 36% tint (see FIG. 3A). This tint is intended for use on bright, sunny days, especially when accurate color detection is desired or critical. By design, it filters all harmful UVR and reduces transmittance of some HEV light, thus enhancing apparent contrast and clarity by reducing the chromatic aberration of the eye. The fact that it does not filter red light, i.e., wavelengths in the LEV range, as much as light at shorter wavelengths allows for better detection of red traffic signals, since the sensitivity of the human visual system to red lights is naturally significantly less than that for yellow and green lights. FIG. 3B shows the plots of the tint on the chromaticity diagram for traffic signals as well as the perceived colors of various light sources.

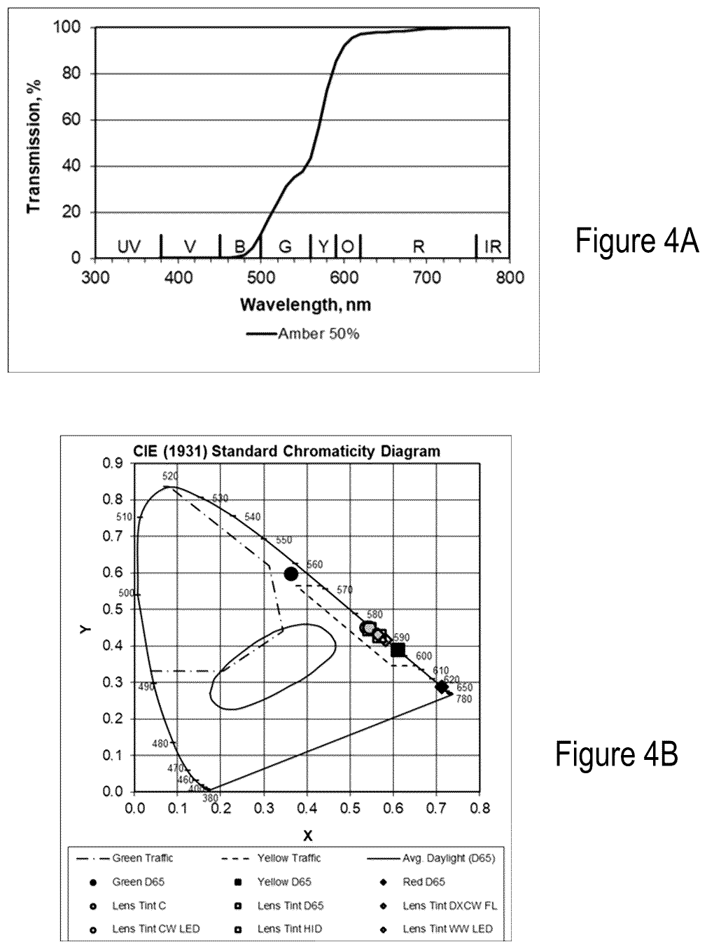

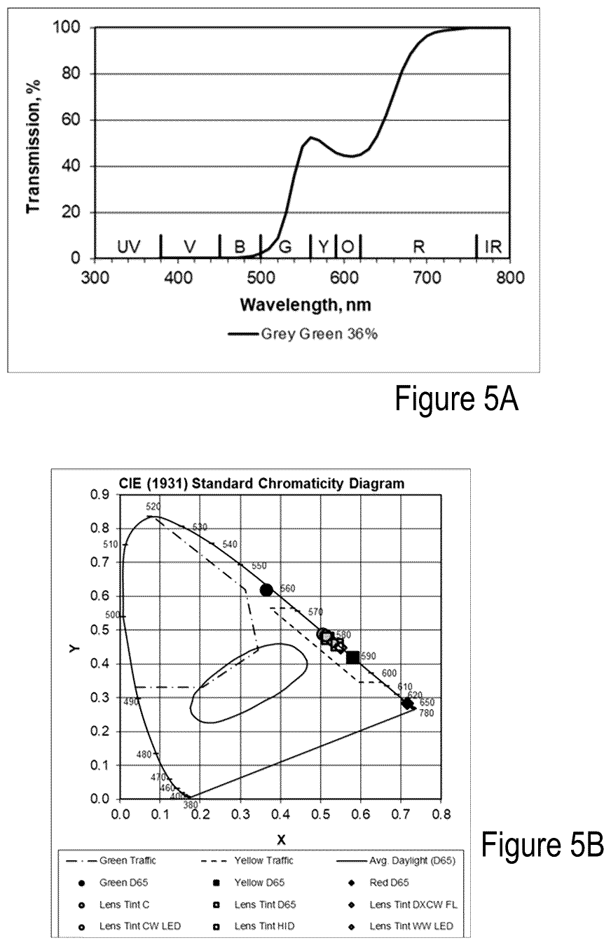

Embodiments that are useful for outdoor activities include the Amber 50% (see FIGS. 4A and 4B) and Grey Green 36% (see FIGS. 5A and 5B) tints. Both tints significantly reduce the chromatic aberration of the eye, thus allowing for easier and faster perception of objects against the background, such as a ball on grass or in the air, or a teammate's (or opponent's) attire. The Amber 50% tint can be more useful when tracking objects in dynamic, reactive sports, such as those that involve a ball or puck, and when lighting conditions vary from bright light to shadow. The Grey Green 36% tint can be more useful in outdoor daylight conditions in varied environments on land or water, including cross-country running and surfing.

In addition to the visual performance benefits of significantly improving clarity and contrast, these 2 tints, and several other tints referenced below which filter most of the HEV range, address the “Blue Light Hazard” from an ocular health standpoint, and also do not compromise the body's natural melatonin secretion for circadian rhythm and sleep cycles. Lastly, while such tints filter much of the VIS, with the relatively sharp increase of transmission near the range of PVS, there is visual comfort and a perceived “Brightening Effect,” which results from the contrast enhancement described above.

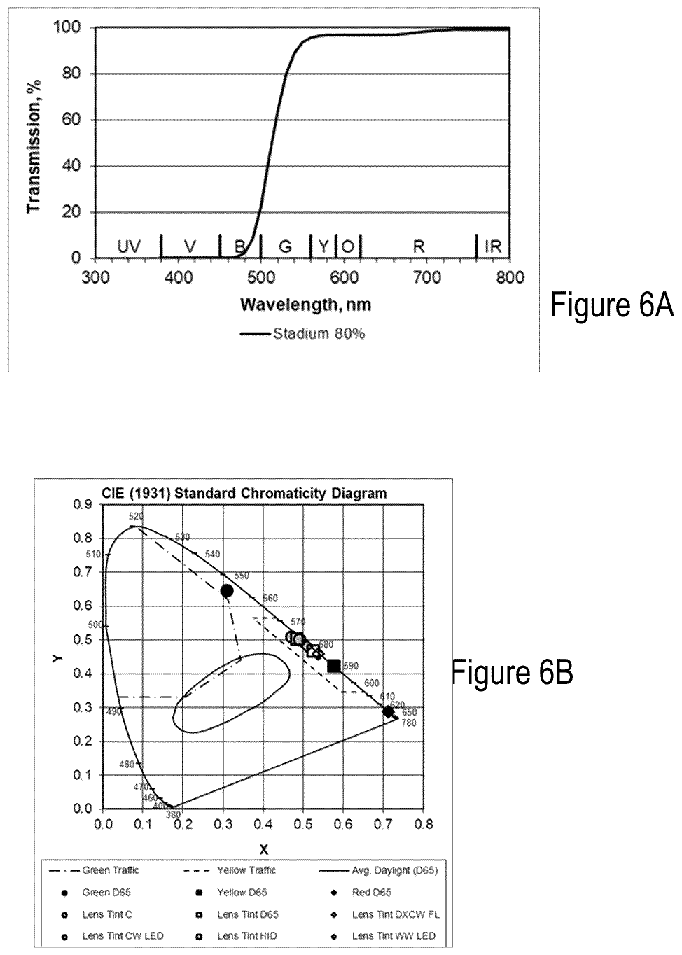

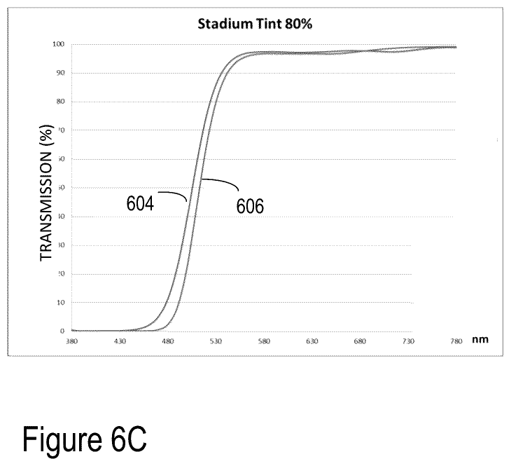

An embodiment that can be useful for activities under HID lighting, such as nighttime sporting events in outdoor and indoor stadiums and arenas, is the Stadium 80% tint (see FIGS. 6a and 6b). This tint significantly reduces the chromatic aberration of the eye by filtering the majority of HEV light. As such, it can enhance the clarity and contrast of objects illuminated under such artificial lighting.

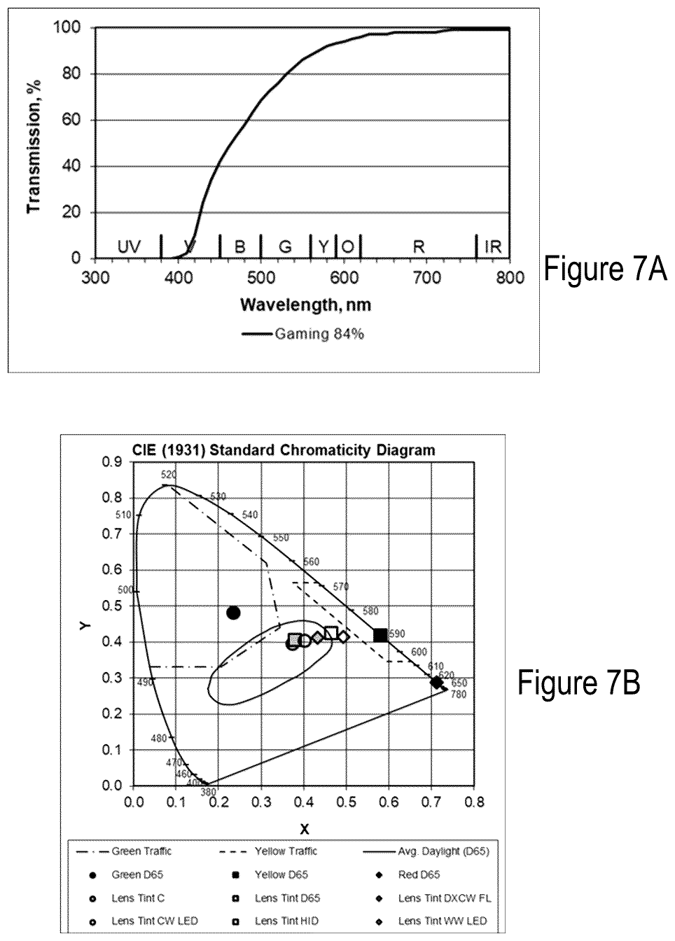

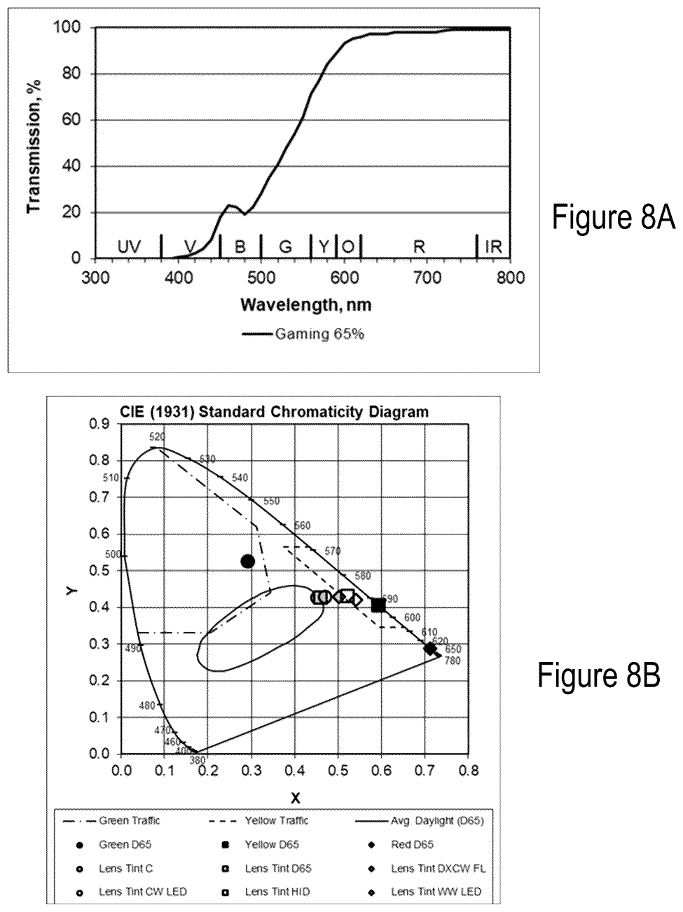

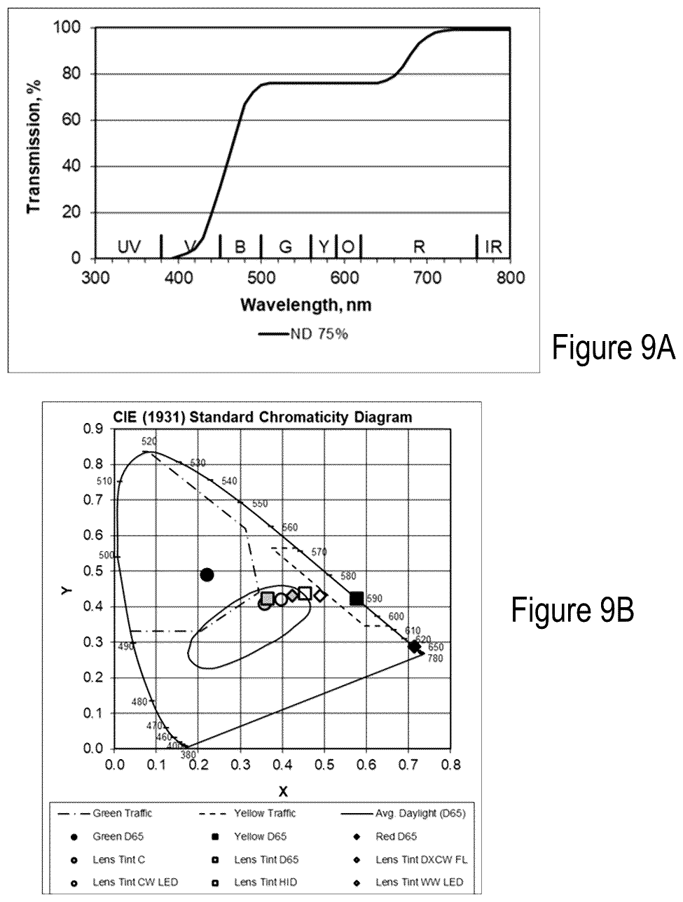

Embodiments that are useful for computer-and monitor-based activities, such as on-line gaming include the Gaming 84% (see FIGS. 7A and 7B), Gaming 65% (see FIGS. 8A and 8B), and ND 75% (see FIGS. 9A and 9B) tints. All of these tints significantly reduce the amount of HEV light produced by the illumination sources of typical monitors and screens, namely fluorescent and LED lights, thus reducing visual stress caused by extended viewing of such devices. The Gaming 84% and ND 75% tints allow for accurate color detection, while the Gaming 65% tint provides for the greatest reduction of visual stress. The Stadium 80% tint can also be used for these activities, with characteristics similar to the Gaming 65% tint but greater overall light transmittance.

### Representative Colorants and Lens Dimensions

While a variety of colorants can be used, the examples disclosed herein can use one or more of the following: Reactive Yellow 15 (CAS Reg. No. 60958-41-0), Reactive Orange 78 (CAS Reg. No. 68189-39-9), Reactive Black 5, CAS Reg. No. 17095-24-8), and Reactive Red 180 CAS Reg. No. 98114-32-0). Color tinting can be applied to a polymerized contact lens by a process similar to that described in Claussen et al, U.S. Pat. No. 4,733,959, which is incorporated herein by reference. Representative dimensions are found in Table 2 below.

TABLE 2
REPRESENTATIVE LENS DIMENSIONS

| | | |
|---|---|---|
| Lens diameter (D) | 12-16 | mm |
| Optical zone diameter (DOZ) | 7-10 | mm |
| Sagittal height (SAG) | 3.5-4.5 | mm |
| Center thickness (CT) | ≥0.12 | mm |
| Posterior surface radius of curvature | 7-9.5 | mm |

| | |
|---|---|
| (PC) (base curve radius) | |
| Anterior surface curvature (AC) | As required for emmetrope or |
| | correction |
| Anterior tinted layer thickness (AT) | As needed for selected spectrum |
| Posterior tinted layer thickness (PT) | As needed for selected spectrum, |
| | AT ≈ PT |

Generally, the entirety of the lens surfaces (both anterior and posterior) can be tinted for complete coverage of the wearer's pupil with the designated light transmittance characteristics over VIS. The contact lens overall diameter can be in the range of 12.0 mm to 16.0 mm with optical zone diameters that range from 7.0 mm to 10.0 mm. The base curve radius on the posterior surface can be in the range of 7.0 mm to 9.5 mm. Thicknesses greater than or equal to 0.12 mm permit easier handling which can be necessary for emmetropes who are unfamiliar with contact lens handling.

Materials which can be used include the following: DA—diacetone acrylamide; DMA—N,N-dimethylacrylamide; HEMA—2-Hydroxyethyl methacrylate; MAA—methacrylic acid; MMA—methyl methacrylate; NCVE—N-carboxl vinyl ester; NVP—N-vinyl pyrrolidone; PBVC-poly[dimethylsiloxyl] di[silybutanol] bis[vinyl carbamate]; PC—phosphorylcholine; TPVC—tris-(trimethylsiloxysilyl) propylvinyl carbamate; and TRIS—tris-(hydroxylmethyl) aminomethane. The listed materials are also known by various adopted names such as polymacon and ocufilcon D. In some examples, ocufilcon D (HEMA, MAA) is used. Soft contact lenses according to the disclosure are made of this or other hydrophilic materials that can be cast molded to permit low cost fabrication as required for a disposable, single use contact lens.

### Representative Contact Lenses

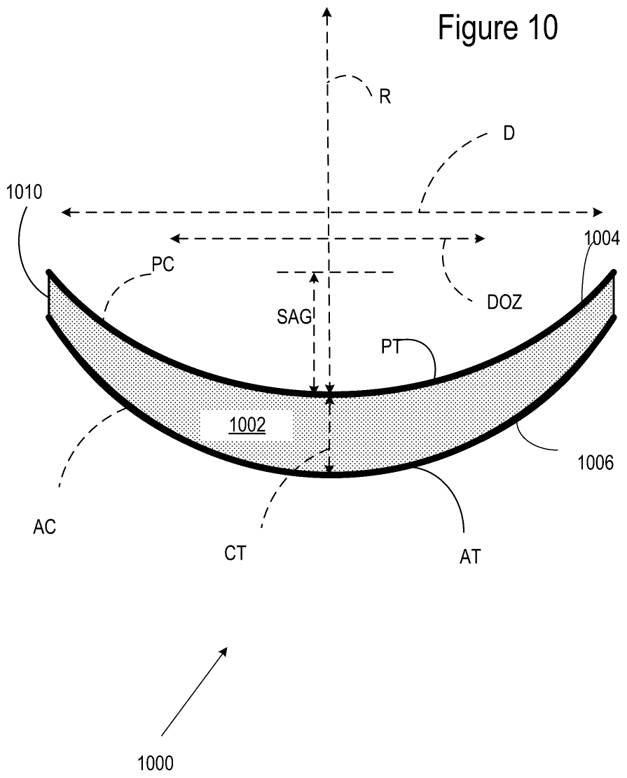

Referring to FIG. 10, a representative task-specific contact lens 1000 (shown in cross-section) includes a base material 1002 having a posterior surface 1004 with a posterior surface curvature PC and an anterior surface 1006 with anterior surface curvature AC. The posterior surface curvature PC contacts a wearer's eye when in used and is typically selected to provide a SAG so that the contact lens 1000 tends to remain stationary on the eye in response to blinking or other disturbances. This can be especially important for use by emmetropes who are unaccustomed to contact lens wear. In addition, for some tasks, momentary disruption of contact lens position on the eye can degrade task-specific vision. An anterior tinted layer AT and a posterior tinted layer PT are situated at the anterior surface 1006 and the posterior surface 1004, respectively. Tinting is generally provided by immersing shaped and polymerized base material in a dye bath so that selected dye or dyes penetrate the anterior surface 1006 and the posterior surface 1004 to produce a selected transmittance spectrum. As shown, the tinted layers generally extend substantially to an edge 1010.

While the posterior surface 1004 is provided with a curvature to promote lens stability and comfort when worn, the anterior surface curvature AC is selected as needed to provide suitable power for vision correction. However, in many cases, intended wearers require no correction. A contact lens providing no corrective power is referred to herein as a “plano” lens although the posterior surface 1004 and the anterior surface 1006 are curved. Spherical or aspherical curvatures can be provided, if desired. A plano lens can have different curvatures on the posterior and anterior surfaces to provide zero optical power.

The contact lens 1000 has a diameter D and defined optical zone having a diameter DOZ with suitable curvatures for vision. A perimeter portion of the contact lens 1000 need not have curvatures controlled for vision and can be thinned or otherwise shaped and still provide wearer comfort and easy handling.

### Notes on Spectral Transmittances (Tints)

FIGS. 1-9 above show light spectra for commonly encountered light sources (FIGS. 1a-1b) and visual spectral response (i.e., appearance of the light from these sources) as shown on a CIE chromaticity diagram (FIG. 2). The enclosed area 202 on FIG. 2 corresponds to CIE coordinate values that are associated with white. Tints associated with CIE coordinates outside of an area such as the coordinate area 202 may alter wearer color perception and in some cases are unsuitable for general purpose wear. The tints of FIGS. 3A-9B generally substantially attenuate HEV light, such as below 500 nm, 475 nm, 450 nm, or shorter. These wavelengths are associated with relatively high light scattering and chromatic aberration. By attenuating these wavelengths, focus and contrast can be improved. Tints that are associated with CIE coordinate values in the coordinate area 202 in response to white illuminants are referred to herein as neutral tints or neutral appearing tints. In some cases, one or a few white illuminants can result in CIE coordinates just outside of this area for a particular tint, but such a tint is still referred to as neutral.

In some cases, contact lenses based on these tints are substantially lighter appearing than conventional tints because placement of a contact lens on the eye eliminates the light leakage around eyeglass lenses, and the tints are effective without being so darkly tinted. For example, the tint of FIG. 3A has an effective transmittance of about 36% and appears generally neutral as shown in FIG. 3B. As another example, the tint of FIG. 9A has an effective transmittance of about 75%. The disclosed task-specific tints do not generally appear neutral and do not permit wearers to accurately respond to color but instead limit the transmitted spectra in ways that can aid vision in performing specific tasks.

The tint shown in FIG. 4A (“amber” tint) attenuates light below about 500 nm, reducing visual noise and improving focus. As shown in FIG. 4B, this tint does not appear neutral. The tints of FIGS. 5A and 6A attenuate HEV light and have effective total transmittances of 36% and 80%, respectively. The tint of FIG. 6a has a high transmittance but effectively eliminates visual noise. FIG. 6C illustrates a design spectrum 606 and an example production spectrum 604. The tints of FIGS. 7A and 8A (“gaming” tints) are suitable for computer gaming (and the FIG. 7A tint permits more accurate color response than some of the previously discussed tints). These tints are selected to reduce fatigue and promote quick response in computer games which are sometimes played for many hours.

FIG. 9B shows another neutral tint with a relatively high transmittance of 75%.

Any of the above tints can have a transmittance that varies by 1%, 2%, or 5% at any wavelength.

### Spectral Transmittance (Tint) Selection

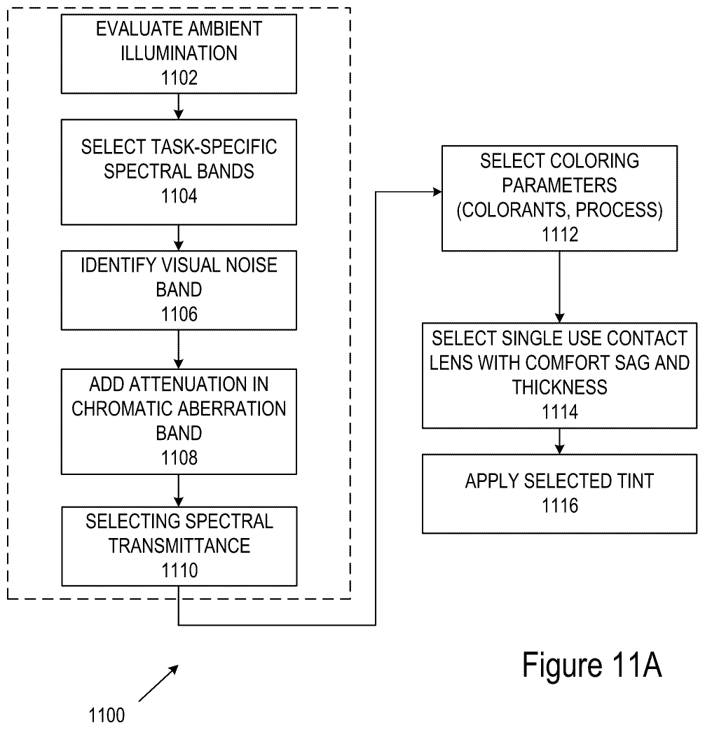

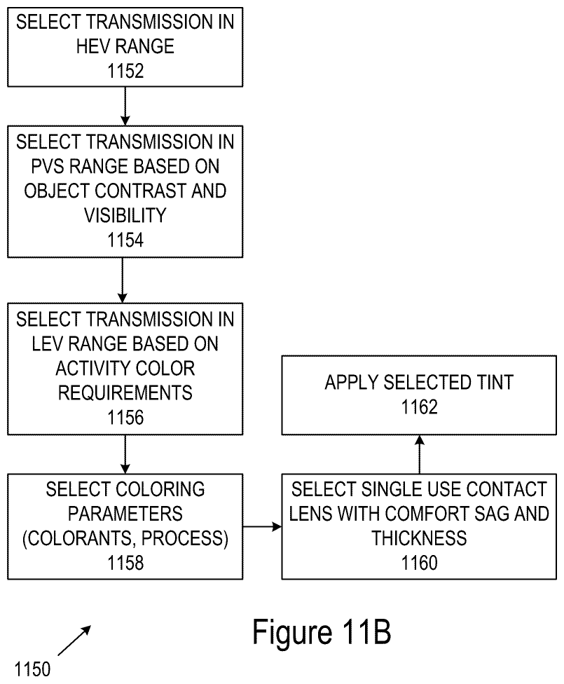

A representative method 1100 of making a task-specific contact lens is illustrated in FIG. 11A. At 1102, ambient illumination associated with the task is evaluated. For example, the type of light source and the associated emission spectrum customarily associated with the task can be evaluated. At 1104, preferred spectral bands are selected and at 1106 visual noise bands are identified. At 1108, a spectral band associated with chromatic aberration reduction can be selected (or can be included in selection of other bands). In some cases, this spectral band is included in the visual noise band and additional attenuation is unneeded. At 1110, a spectral transmittance can be selected based at least in part on the above steps. At 1112, colorants and coloring process parameters are selected to produce the desired spectral transmittance, typically as incorporated into anterior and posterior surface layers of a selected contact lens base. At 1114, a contact lens is selected based on a SAG and thickness associated with wearer comfort and, if necessary, optical correction of the wearer, and at 1116, the selected tint is realized by coloring the anterior and posterior surfaces of the contact lens.

In another example, shown in FIG. 11B, a method 1150 includes selecting transmission in an HEV wavelength range at 1152, in some cases, to reduce visual noise. At 1154, transmission in a PVS wavelength range is selected to enhance object contrast and visibility, typically in consideration of the anticipated illumination. At 1156, transmission in an LEV wavelength range is selected to provide suitable color. At 1158, colorants and color processes are selected and at 1160 physical properties of a contact lens such as sag and thickness are selected (and any curvatures for vision correction). At 1162, tint is applied.

### Chromatic Aberration and Visual Noise Reduction

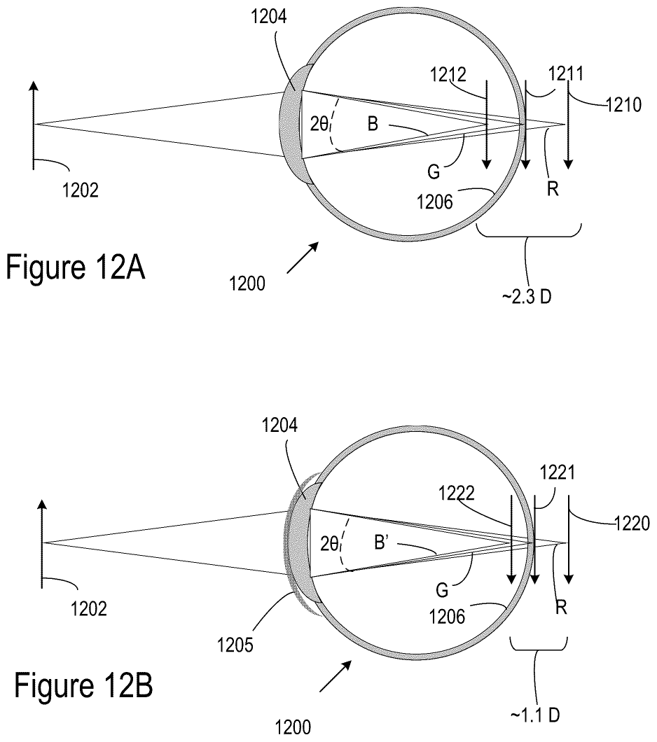

Referring to FIG. 12A, an eye 1200 includes a lens 1204 which is used to produce an image of an object 1202 (shown as is customary with an arrow) on a retina surface 1206. For convenience, all focusing power is described as included in the lens 1204 but in a normal human eye, focusing is provided by a lens (variable) and a cornea (fixed). For imaging in white light, the lens 1204 focuses to produce images 1210, 1211, 1212 that are associated with red (R), green (G), and blue (B) color components as shown. With the image 1211 associated with green focused on the retina 1206, the images 1210, 1212 associated with red and blue are directed to be focused behind the retina 1206 or in front of the retina 1206 as shown. The lens 1204 has a higher refractive index for short wavelengths so that the image 1212 is situated in front of the retina 1206. The separation of the images 1210, 1212 corresponds to a 2.3 D power difference needed to image HEV (blue) light and LEV (red) light similarly to PVS (green) light which is shown as focused on the retina 1206. The associated blur is a function (a product) of an angular spread θ of the focused beams and the longitudinal chromatic aberration (the distance between the B and R focal points); this blur produces visual noise. With a suitable tinted contact lens 1205 as shown in FIG. 12B, R, G, B′ images 1220, 1221, 1222 have a small separation, correspond to 1.1 D power difference, reducing visual blur and noise. The separation of the B′-R images is less than that of the B-R images of FIG. 12a, illustrating reduced chromatic aberration. In this example, B′ indicates shorter wavelengths but with some portions of the blue wavelengths attenuated or blocked. Note that as shown, the tinted contact lens 1205 provides no additional optical power, only spectral attenuation.

FIGS. 4A and 5A illustrate spectra of representative tinted contact lenses that can be used to reduce visual noise as shown in FIGS. 12A-12B. FIG. 4A illustrates a tinted contact lens having a spectral transmittance associated with an amber appearance and FIG. 5B illustrates a tinted contact lens having spectral transmittance associated with a grey-green visual appearance. Both of these tints have nearly complete blockage at wavelengths less than 480 nm and produce substantial attenuation. While visual noise reduction is illustrated without contact lens power, similar reductions in visual noise can be obtained with corrective lenses such as used for myopes and hyperopes.

### Representative Myopia Control Contact Lenses

Contact lenses and other eyewear can be provided with spectral transmissivities that can be applied to slowing or preventing myopia development. In typical examples, contact lenses such as described above can provide 360 degree total tint immersion and virtually eliminate all the environmental and optical limitations of eyewear, including compromising peripheral light leakage on the effectivity of the tint in myopia control. In addition, the disclosed contact lenses are configured for relatively easy user handling such as contact lens insertion and removal. Since the amber tint of FIG. 4B transmits wavelengths greater than 500 nm, this tint allows for better color perception and discrimination than any narrow-band tint, such as a red tint. Thus, using this tint can permit myopia control with lenses that provide acceptable color vision.

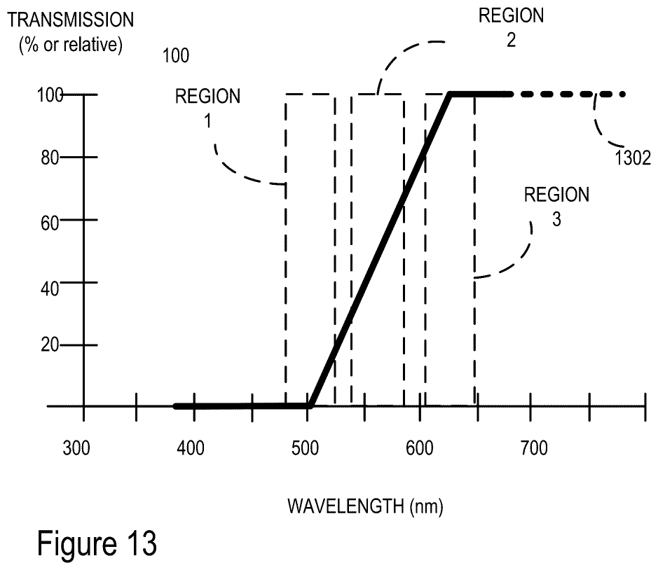

Generally, tints that appear yellow-orange based on relatively high filter transmittances at one or more wavelengths greater than 500 nm can be used. Such tints are illustrated by the spectral transmittance curve illustrated in FIG. 13. This transmittance curve can be divided into Regions 1-3, defined by transmittance in wavelength regions 480-520 nm, 540-580 nm, and 610 nm to 650 nm, respectively. Transmittance at wavelengths shorter than those of Region 1 is generally selected to be less than 0.1%, 0.2%, 0.5%, 1%, 2%, or 5%. In Region 1, filter transmittance rises to 5-10%; in Region 2, transmittance transitions from the low values at wavelengths less than those of Region 1 to reach 40-60%. In Region 3, transmittance becomes higher than in Region 2 and remains high, between 80-100%. At still longer wavelengths, transmittance general remains high as well, but long wavelengths associated with a dashed portion 1302 of the transmittance curve are of lesser importance as the eye's sensitivity to these wavelengths is small. For convenience, transmittances (absolute and/or relative) such as shown in FIG. 13 (and FIG. 4A) are referred to herein in some examples as myopia control tints. The same tints can be used to provide relief of brain injury, migraines, and concussion in some cases.

Transmittances are generally described as absolute filter transmittances absent losses due to Fresnel reflection at filter surfaces for convenience; the same or similar values of relative transmittances can be used as well with the disadvantage that the overall transmission may be low and vision seem darkened. Similar effects can be obtained with multiple narrow band regions, and any of the Regions 1-3 can have spectral windows of width 2-5 nm having transmittances uncharacteristic of the respective region. As used herein, low transmittance refers to an absolute or relative transmittance of less than 5%, 2%, 1%, or less.

In the examples, tints are provided as surface layers as dyes that extend throughout a filter volume tend to produce different optical densities for different optical powers. With such through tints, different powers provided to lenses for different eyes would produce an uncomfortable light/dark imbalance between the eyes. In addition to the advantages noted above, myopia control tints tend to reduce the apparent defocus or blur experienced by users in dual focus lenses as disclosed below.

### Dual Focus Contact Lenses with Myopia Control Tints

The example contact lenses discussed above are single-vision contact lenses that provide a single optical power (including zero optical power). However, myopia control tints implemented in dual focus contact lenses or other vision correction optics such as goggles or spectacles may provide even superior myopia control.

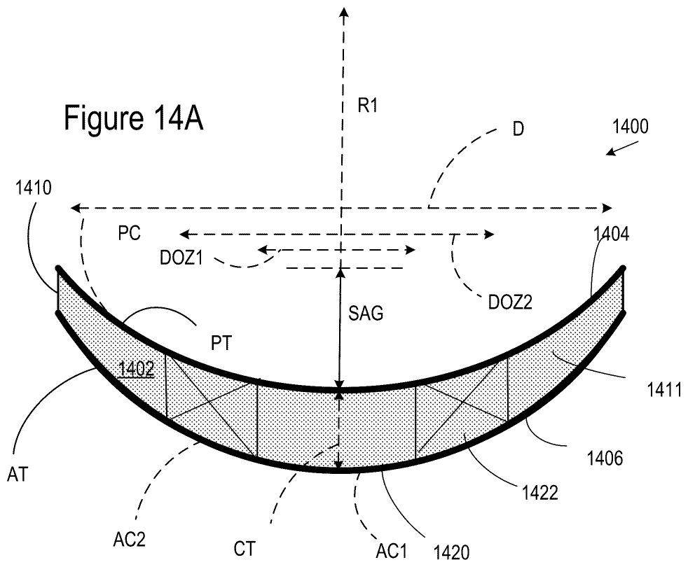

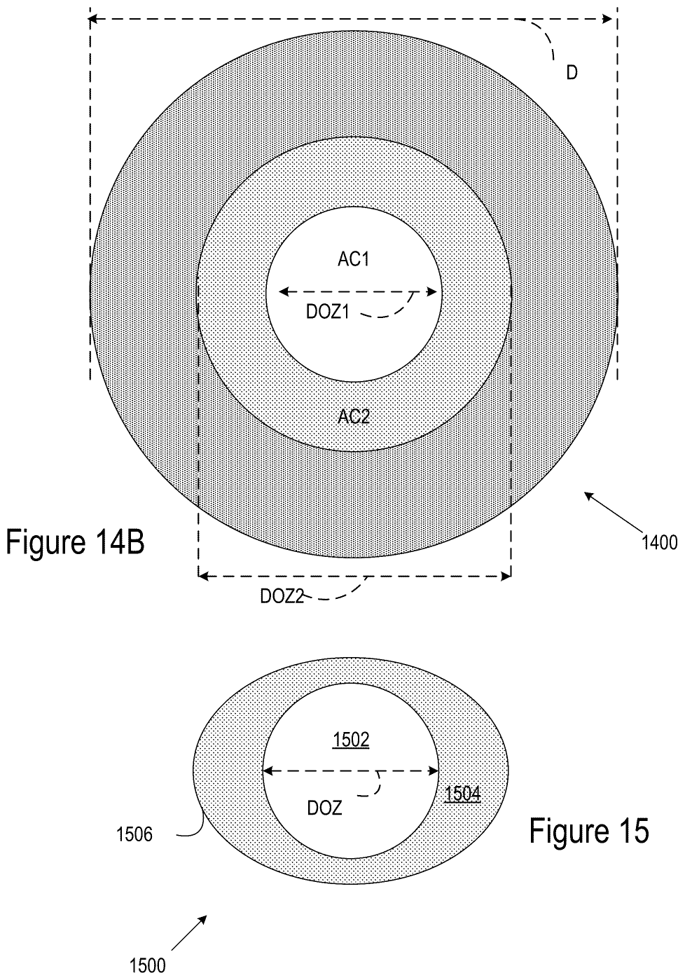

Referring to FIGS. 14A-14B, a representative dual-focus contact lens 1400 (shown in cross-section) includes a base material 1402 having a posterior surface 1404 with a posterior surface curvature PC and an anterior surface 1406 with a central anterior surface curvature AC1 and a peripheral anterior surface curvature AC2 in a first optical zone 1420 and a second optical zone 1422, respectively. A perimeter (non-optical) region 1411 extends from the second zone 1422 to an edge 1410. Typically, there is an intermediate area between the first optical zone 1420 and the second optical zone 1422 that is not shown in FIGS. 14A-14B. In the example of FIGS. 14A-14b, differences in the curvatures AC1 and AC2 are slight so that anterior surface appears continuous. The posterior surface curvature PC contacts a wearer's eye when in use and is typically selected to provide a SAG so that the contact lens 1400 tends to remain stationary on the eye in response to blinking or other disturbances. This can be especially important for use by children who are unaccustomed to contact lens wear. An anterior tinted layer AT and a posterior tinted layer PT are situated at the anterior surface 1406 and the posterior surface 1404, respectively. Tinting is generally provided by immersing shaped and polymerized base material in a dye bath so that selected dye or dyes penetrate the anterior surface 1406 and the posterior surface 1404 to produce a selected transmittance spectrum. As shown, the tinted layers generally extend substantially to the edge 1410 although the perimeter region 1411 tapers to provide comfort and stability but does not pass light to the retina.

While the posterior surface 1404 is provided with a curvature to promote lens stability and comfort when worn, the anterior surface curvatures AC1, AC2 are selected as needed to provide suitable powers for myopia control. For example, the central anterior curvature AC1 is selected to provide clear vision (i.e., provide focus on the wearer's retina) and can provide an optical power between −5 and +5 D, including 0 D while the peripheral anterior curvature AC2 is select to focus in front of the wearer's retina, and has an optical power having a magnitude that differs from the power of the central anterior curvature AC1 by between 0.05 and 2 D. In other cases, the power of the peripheral anterior curvature AC2 is select to focus on the wearer's retina, and the power of the central anterior curvature AC1 is selected to provide a focus in front of the retina and has an optical power that differs from the power of the peripheral anterior curvature AC2 by between 0.05 and 2 D. As used herein, a surface curvature or optical power associated with surface or portion of a surface is referred to as providing clear vision if associated with a wearer's perception of focus. Clear vision is generally associated with focus at the retina.

The contact lens 1400 has a diameter D and defines a central optical zone having a diameter DOZ1 associated with the central anterior curvature AC1 and a peripheral optical zone having a diameter DOZ2 associated with the peripheral anterior curvature AC2. The diameters DOZ1 and DOZ2 are selected to provide acceptable vision to the wearer while admitting (via the peripheral optical zone) sufficient light for misfocus in front of the retina to promote emmetropization. The diameter D of the contact lens 1400 extends so that only light passing through the anterior tinted layer AT and the posterior tinted layer PT can be transmitted to the wearer's retina with suitable curvatures for vision. A perimeter portion of the contact lens 1400 need not have curvatures controlled for vision and can be thinned or otherwise shaped and still provide wearer comfort and easy handling. Representative dimensions can be found in Table 3 below.

TABLE 3
Representative dual focus myopia control lens dimensions

| | |
|---|---|
| Lens diameter (D) | 12-16 mm |
| Central optical zone diameter (DOZ1) | 7-10 mm |
| Peripheral optical zone diameter | 1-3 mm less than DOZ1; can extend |
| (DOZ2) | to full lens diameter D |
| Posterior surface radius of curvature | 7-9.5 mm |
| (PC) (base curve radius) | |
| Central anterior surface curvature | As required for emmetrope or |
| (AC1) | correction |
| Peripheral anterior surface curvature | At least 0.05-5.0 D greater than AC1 |
| (AC2) | |

The contact lens 1400 also includes a perimeter zone 1408 about the peripheral optical zone 1422 that has a diameter such that this zone does not direct light into the eye and can be shaped as needed based on other considerations. The central optical zone diameter (DOZ1) can be selected to correspond to 50%, 75%, 80%, 85%, 90%, 95%, 97.5% or other fraction of a pupil diameter associated with a contact lens wearer. Pupil diameter varies among users and even for a single user varies in response to light and to wearer interest in objects within a field of view. Typical pupil diameters range from 2-4 mm in bright light and 4-8 mm in the dark and a central optical zone diameter is generally selected to permit the perimeter optical zone 1422 to direct light to the retina under normal lighting conditions. A standard pupil diameter of 4 mm can be used as a reference, but pupil diameter for an individual wearer can also be selected based on measurement or upon user characteristics such as age.

### Dual Focus Optics with Myopia Control Tints

Chromaticity and dual focus can be provided in other optics such as eyeglass lenses and goggle lenses. As shown in FIG. 15, a lens 1500 includes a first zone 1502 (shown as a central zone) and a second zone 1504 (shown as a perimeter zone. The first zone 1502 has a diameter D and the second zone 1504 extends to a lens edge 1506. Typically, the first zone 1502 is adapted to provide clear vision while the second zone 1504 provides defocus to stimulate emmetropization but the zones can be configured in other ways. Typical values for the second zone 1504 provide 0.01-5 D of optical power difference from the optical power of the first zone 1502. The lens 1502 includes at least one tinted layer at a lens anterior surface (outward facing in use) and a lens posterior surface (inward facing in use). In other examples, optical power does not change step-wise from zone to zone but is graded, typically from a central area toward a lens perimeter.

### General Considerations

As discussed above, the disclosed tinted contact lenses are arranged to provide comfort and ease of use, particularly for individuals who normally use no visual correction. As used herein, those requiring no correction (or corrections of magnitude of less than 0.1 D, 0.05 D, or 0.025 D) are referred to as emmetropes. Individuals requiring larger positive correction (such as greater than 0.1 D are referred to as hyperopes and individuals requiring negative values <−0.1 D are referred to as myopes. For any such users, astigmatism correction can be included. In some examples, the disclosed tinted contacts are configured for short-term use (less than 2-10 hours), permitting reduced oxygen permeability. Tinted contact lenses providing reduction of chromatic aberration to less than 1.2 D, 1.1 D, 1.0 D, 0.9 D, 0.8 D or less are referred to herein as chromatic aberration corrected.

In the examples above, specific transmission values are provided but these can vary by ±1%, ±2%, ±5%, ±10%, ±15%, or ±20%. Larger variations are permitted in regions in which transmission varies rapidly, i.e., as rapidly as more than 1%/nm, 2%/nm, or 3%/nm (such as between 480 nm and 550 nm in FIG. 6C). Transmission values outside of the visual range 400-760 nm can generally be arbitrary as they do not contribute substantially to visual perception. Transmittance values are “luminous transmittance,” i.e., physical transmittance for at each wavelength weighted by a visual sensitivity function of the human eye.

### REPRESENTATIVE EXAMPLES

Example 1 is a task-specific, single use contact lens, including: a contact lens base having an anterior surface, a posterior surface, and a diameter of between 12 mm and 16 mm, wherein: the posterior surface has a sag of at least 3.5 mm and a curvature of between 7 mm and Example 9.5 mm, and tinted layers situated at the anterior surface and the posterior surface.

Example 2 includes the subject matter of Example 1, and further specifies that the contact lens base is ocufilcon D.

Example 3 includes the subject matter of any of Examples 1-2, and further specifies that the contact lens base is tinted so that transmission at wavelengths less than 400 nm is less than 1% and at wavelengths between 400 nm and 450 nm is less than 40%.

Example 4 includes the subject matter of any of Examples 1-3, and further specifies that the transmission at wavelengths between 400 nm and 450 nm is less than 2%

Example 5 includes the subject matter of any of Examples 1-4, and further specifies that the contact lens base is tinted so that transmission at wavelengths between 650 nm and 700 nm is greater than 80%.

Example 6 includes the subject matter of any of Examples 1-5 wherein the contact lens is tinted so that transmission at wavelengths greater than 560 nm is at least 90% and transmission at wavelengths less than 480 nm is less than 2%.

Example 7 includes the subject matter of any of Examples 1-6, and further specifies that the contact lens base is tinted so that transmission at wavelengths greater than 620 is at least 95% and monotonically increases from at least 20% at 500 nm to at least 80% at 600 nm.

Example 8 includes the subject matter of any of Examples 1-7, tinted layer has a transmissivity corresponding to a stadium tint having an 80% effective transmittance.

Example 9 includes the subject matter of any of Examples 1-8, and further specifies that the contact lens base is tinted so that transmission at wavelengths greater than 620 is at least 95% and monotonically increases from at least 30% at 450 nm to at least 90% at 600 nm.

Example 10 includes the subject matter of any of Examples 1-9, and further specifies that the tinted layer has a transmissivity corresponding to a gaming tint having an effective transmittance of 84%.

Example 11 includes the subject matter of any of Examples 1-10, and further specifies that the contact lens base is tinted so that transmission at wavelengths between 400 nm and 450 nm increases monotonically from less than 2% at 400 nm to less than 25% but less than 30% at 450 nm and at wavelengths between 500 nm and 650 nm monotonically increases from at least 20% at 500 nm to at least 90% at 650 nm.

Example 12 includes the subject matter of any of Examples 1-11, and further specifies that the tinted layer has a transmissivity corresponding to a gaming tint having an effective transmittance of 84%.

Example 13 includes the subject matter of any of Examples 1-12, and further specifies that the contact lens base is tinted so that transmission at wavelengths less than 480 nm is less than 2%, at least 40%, at wavelengths between 580 nm and 620 nm, and monotonically increases from at least 40% at 620 nm to at least 90% at 700 nm.

Example 14 includes the subject matter of any of Examples 1-13, and further specifies that the contact lens base is tinted to have a transmissivity corresponding to a grey-green tint.

Example 15 includes the subject matter of any of Examples 1-14, and further specifies that the contact lens base is tinted so that transmission at wavelengths less than 480 nm is less than 10% and monotonically increases from at least 10% at 520 nm to at least 95% at 620 nm.

Example 16 includes the subject matter of any of Examples 1-15, and further specifies that the contact lens base is tinted to have a transmissivity corresponding to an amber tint.

Example 17 includes the subject matter of any of Examples 1-16, and further specifies that the contact lens base is tinted so that transmission at wavelengths less than 450 nm is less than 20%, between 30% and 40% between 460 nm and 580 nm, and monotonically increases from at least 40% at 620 nm to at least 95% at 700 nm.

Example 18 includes the subject matter of any of Examples 1-17, and further specifies that the contact lens base is tinted to have a transmissivity corresponding to a chromatic aberration reduced, neutral tint having a transmittance of at least 36%.

Example 19 includes the subject matter of any of Examples 1-18, and further specifies that the contact lens base is tinted so that transmission at wavelengths less than 450 nm is less than 40%, between 70% and 80% between 500 nm and 640 nm, monotonically increases from 450 nm to 500 nm, and is at least 95% at between 760 nm and 800 nm.

Example 20 includes the subject matter of any of Examples 1-19, and further specifies that the contact lens base is tinted to have a transmissivity corresponding to a chromatic aberration reduced, neutral tint having a transmittance of at least 75%.

Example 21 includes the subject matter of any of Examples 1-20, and further specifies that the diameter is at least 14 mm.

Example 22 includes the subject matter of any of Examples 1-21, and further specifies that has the sag of the posterior surface is at least 5 mm.

Example 23 includes the subject matter of any of Examples 1-22, and further specifies that the curvature is at least 8.5 mm.

Example 24 includes the subject matter of any of Examples 1-23, and further specifies that a magnitude of a lens power is less than 0.1 D.

Example 25 includes the subject matter of any of Examples 1-24, and further specifies that a magnitude of a lens power is less than 0.05 D.

Example 26 is a myopia control contact lens, including: a contact lens base having an anterior surface and a posterior surface, wherein the posterior surface has a curvature adapted to curvature of a wearer's eye; and the anterior surface and the posterior surface having an anterior surface layer and a posterior surface layer, respectively, the anterior surface layer and the posterior surface layer having a myopia control tint.

Example 27 includes the subject matter of Example 26, wherein the contact lens base has a diameter of between 12 mm and 16 mm and the posterior surface has a sag of at least 3.5 mm and a curvature of between 7 mm and 9.5 mm.

Example 28 includes the subject matter of any of Examples 26-27, and further specifies that the myopia control tint is an amber tint.

Example 29 includes the subject matter of any of Examples 26-28, and further specifies that the anterior surface has a curvature adapted to provide clear vision.

Example 30 includes the subject matter of any of Examples 26-29, and further specifies that the anterior surface has a first curvature and a second curvature that define a first optical zone and a second optical zone, respectively, wherein the first optical zone and the second optical zone are adapted to direct light into the wearer's eye in an as-worn position.

Example 31 includes the subject matter of any of Examples 26-30, and further specifies that the first optical zone has refractive power adapted to provide the wearer with clear vision and the second optical zone has a refractive power different from the refractive power of the first optical zone.

Example 32 includes the subject matter of any of Examples 26-31, and further specifies that the first optical zone is a central optical zone and the second optical zone is a peripheral optical zone situated about the first optical zone and/or example 32 further specifies includes that the contact lens base has a diameter of between 12 mm and 16 mm and the posterior surface has a sag of at least 3.5 mm and a curvature of between 7 mm and 9.5 mm.

Example 33 includes the subject matter of any of Examples 26-32, and further specifies that a refractive power of the peripheral optical zone is at least 0.5 D greater than that of the central optical zone.

Example 34 includes the subject matter of any of Examples 26-33, and further specifies that a refractive power of the peripheral optical zone is at least 1.0 D greater than that of the central optical zone.

Example 35 includes the subject matter of any of Examples 26-34, and further specifies that a refractive power of the central optical zone is 0 D.

Example 36 includes the subject matter of any of Examples 26-35 and further specifies that the central optical zone has a diameter of at least 4 mm.

Example 37 includes the subject matter of any of Examples 26-36, and further specifies that a diameter of the central optical zone is between 50-95% of a pupil diameter.

Example 38 includes the subject matter of any of Examples 26-37, and further specifies that a diameter of the central optical zone is 1 mm less than a diameter of a pupil of a wearer's eye.

Example 39 includes the subject matter of any of Examples 26-38, and further specifies that a diameter of the central optical zone is between 1 and 3 mm less than a diameter of a pupil of the wearer's eye.

Example 40 includes the subject matter of any of Examples 26-39, and further specifies that a diameter of the contact lens base is at least 15 mm.

Example 41 includes the subject matter of any of Examples 26-40, and further specifies that the sag of the posterior surface is at least 5 mm.

Example 42 includes the subject matter of any of Examples 26-41, and further specifies that the anterior surface defines an edge region situated about the peripheral optical zone.

Example 43 is a method, including: providing a first optical power and a second optical power for a first optical zone and a second optical zone, respectively, of a contact lens, wherein the first optical power is selected to provide clear vision based on light transmitted through the first optical zone and the second optical power is different from the first optical power; and proving a myopia control tint at an anterior surface and a posterior surface of the contact lens.

Example 44 includes the subject matter of Example 43, and further specifies that the contact lens is defined on a contact lens base having a diameter of between 12 mm and 16 mm and the posterior surface has a sag of at least 3.5 mm and a curvature of between 7 mm and 9.5 mm, and the first optical zone is a central optical zone and the second optical zone is a peripheral optical zone situated about the first optical zone, the second optical zone having an optical power that is greater than first optical power by at least 0.5 D, 1.0D, or 2.0D.

Example 45 is an optic for myopia control, including an optical substrate having myopia control tint at least one of an anterior surface layer and a posterior surface layer, the optical substrate defining a first optical zone associated with clear vision and a second optical zone associated with defocus.

Example 46 includes the subject matter of Example 45, and further specifies that the first optical zone is adapted to be situated along a user line of sight in use.

Example 47 includes the subject matter of any of Examples 45-46, and further specifies that the optical substrate is a lens substrate.

Example 48 includes the subject matter of any of Examples 45-47, and further specifies that the second optical zone has an optical power that differs from an optical power of the first optical zone by at least 1 D.

Example 49 includes the subject matter of any of Examples 45-48, and further specifies that the myopia control tint is an amber tint such as the amber tint of FIG. 4A.

In view of the many possible embodiments to which the principles of the disclosed technology may be applied, it should be recognized that the illustrated embodiments are only preferred examples of and should not be taken as limiting the scope of the disclosure.

We claim:

1. A myopia control contact lens, comprising:
a contact lens base having an anterior surface and a posterior surface, wherein the posterior surface has a curvature adapted to curvature of a wearer's eye; and
the anterior surface and the posterior surface having an anterior surface layer and a posterior surface layer, respectively, the anterior surface layer and the posterior surface layer having a myopia control tint.

2. The myopia control contact lens of claim 1, the contact lens base has a diameter of between 12 mm and 16 mm and the posterior surface has a sag of at least 3.5 mm and a curvature of between 7 mm and 9.5 mm.

3. The myopia control contact lens of claim 1, wherein the myopia control tint is an amber tint.

4. The myopia control contact lens of claim 1, wherein the anterior surface has a curvature adapted to provide clear vision.

5. The myopia control contact lens of claim 1, wherein the anterior surface has a first curvature and a second curvature that define a first optical zone and a second optical zone, respectively, wherein the first optical zone and the second optical zone are adapted to direct light into the wearer's eye in an as-worn position.

6. The myopia control contact lens of claim 5, wherein the first optical zone has refractive power adapted to provide the wearer with clear vision and the second optical zone has a refractive power different from the refractive power of the first optical zone.

7. The myopia control contact lens of claim 5, wherein the first optical zone is a central optical zone and the second optical zone is a peripheral optical zone situated about the first optical zone.

8. The myopia control contact lens of claim 7, the contact lens base has a diameter of between 12 mm and 16 mm and the posterior surface has a sag of at least 3.5 mm and a curvature of between 7 mm and 9.5 mm.

9. The myopia control contact lens of claim 8, wherein a refractive power of the peripheral optical zone is at least 0.5 D greater than that of the central optical zone.

10. The myopia control contact lens of claim 8, wherein a refractive power of the peripheral optical zone is at least 1.0 D greater than that of the central optical zone.

11. The myopia control contact lens of claim 8, wherein a refractive power of the central optical zone is 0 D.

12. The myopia control contact lens of claim 8, wherein the central optical zone has a diameter of at least 4 mm.

13. The myopia control contact lens of claim 8, wherein a diameter of the central optical zone is at least 90% of a pupil diameter.

14. The myopia control contact lens of claim 8, wherein a diameter of the central optical zone is 1 mm less than a diameter of a pupil of a wearer's eye.

15. The myopia control contact lens of claim 8, wherein a diameter of the central optical zone is between 1 and 3 mm less than a diameter of a pupil of the wearer's eye.

16. The myopia control contact lens of claim 8, wherein a diameter of the contact lens base is at least 14 mm.

17. The myopia control contact lens of claim 8, wherein the sag of the posterior surface is at least 5 mm.

18. The myopia control contact lens of claim 8, wherein the anterior surface defines an edge region situated about the peripheral optical zone.

19. A method, comprising:
providing a first optical power and a second optical power for a first optical zone and a second optical zone, respectively, of a contact lens, wherein the first optical power is selected to provide clear vision based on light transmitted through the first optical zone and the second optical power is different from the first optical power; and
providing a myopia control tint at an anterior surface and a posterior surface of the contact lens.

20. The method of claim 19, wherein the contact lens is defined on a contact lens base having a diameter of between 12 mm and 16 mm and the posterior surface has a sag of at least 3.5 mm and a curvature of between 7 mm and 9.5 mm, and the first optical zone is a central optical zone and the second optical zone is a peripheral optical zone situated about the first optical zone, the second optical zone having an optical power that is greater than first optical power by at least 0.5 D, 1.0 D, or 2.0 D.

21. An optic for myopia control, comprising an optical substrate having myopia control tint at least one of an anterior surface layer and a posterior surface layer, the optical substrate defining a first optical zone associated with clear vision and a second optical zone associated with defocus.

22. The optic of claim 21, wherein the first optical zone is adapted to be situated along a user line of sight in use.

23. The optic of claim 21, wherein the optical substrate is a lens substrate.

24. The optic of claim 21, wherein the second optical zone has an optical power that differs from an optical power of the first optical zone by at least 1 D.

25. The optic of claim 21, wherein the myopia control tint is an amber tint.
